(19) United States
(12) Patent Application Publication
(10) Pub. No.: US 2016/0107599 A1
(43) Pub. Date: Apr. 21, 2016

(54) CURTAIN AIRBAG

(71) Applicant: Hyundai Mobis Co., Ltd., Seoul (KR)

(72) Inventor: Jong Seob LEE, Yongin-si (KR)

(21) Appl. No.: 14/695,380

(22) Filed: Apr. 24, 2015

(30) Foreign Application Priority Data
Oct. 17, 2014 (KR) 10-2014-0141129

(51) Int. Cl. B60R 21/232; B60R 21/237

(52) U.S. Cl. CPC B60R 21/232; B60R 21/237

(57) ABSTRACT

Provided is a curtain airbag that prevents a head of an occupant from being moved forward and trapped between the curtain airbag and a drive airbag. To this end, the curtain airbag according to the exemplary embodiment of the present invention includes: a first panel which forms one surface; and a second panel which forms the other surface, and is greater in length in a front and rear direction than the first panel, in which the second panel has a folded portion which is folded so that the second panel has the same length in the front and rear direction as the first panel, and coupled to the first panel.

### CROSS-REFERENCE TO RELATED APPLICATION

The present application claims priority from and the benefit of Korean Patent Application Number 10-2014-0141129, filed on Oct. 17, 2014, the entire contents of which the application is incorporated herein for all purposes by this reference.

### BACKGROUND

1. Field

The present invention relates to a curtain airbag, and more particularly, to a curtain airbag that is installed in a vehicle and elongated in a front and rear direction.

2. Discusion of the Background

In general, curtain airbags are installed at left and right sides of a vehicle, respectively. In more detail, the curtain airbags are installed in inner side panels, which are disposed at lateral upper sides of the vehicle, and elongated in a front and rear direction of the vehicle.

The curtain airbag is deployed from the upper side toward the lower side at the time of a vehicle accident, and disposed between a door of the vehicle and the head of an occupant, thereby protecting the head of the occupant.

FIG. 1 is a schematic view of a curtain airbag, a driver airbag and the head of the occupant according to the related art when viewed from the upper side.

Referring to FIG. 1, a driver airbag 2a is additionally installed in a steering wheel in the vehicle. In addition, in order to protect an occupant seated in a front passenger seat, a passenger airbag (not illustrated) is also installed at the upper side of a glove box that is disposed in front of the front passenger seat in the vehicle.

Typically, the driver airbag and the passenger airbag are deployed when the vehicle is involved in a head-on collision, and the curtain airbags are deployed when the vehicle is involved in a broadside collision or a rollover accident, and the driver airbag 2a, the passenger airbag, and the curtain airbags 1a are deployed when the vehicle obliquely collides with an object.

When the vehicle collides with an object as described above, the upper body of the occupant is bent forward by inertial force, and a head 3a of the occupant is moved forward. In particular, when the vehicle obliquely collides with an object, the head 3a of the occupant is obliquely moved forward, and trapped between the driver airbag 2a and the curtain airbag 1a or trapped between the passenger airbag and the curtain airbag 1a.

The above information disclosed in this Background section is only for enhancement of understanding of the background of the inventive concept, and, therefore, it may contain information that does not form the prior art that is already known in this country to a person of ordinary skill in the art.

### SUMMARY

Embodiments of the present invention provide a curtain airbag that prevents a head of an occupant from being moved forward.

Technical problems solved by embodiments of the present invention are not limited to the aforementioned technical problem, and other technical solutions, which are not mentioned above, may be clearly understood by those skilled in the art from the following descriptions.

An exemplary embodiment of the present invention provides a curtain airbag including: a first panel which forms one surface; and a second panel which forms the other surface, and is greater in length in a front and rear direction than the first panel, in which the second panel has a folded portion which is folded so that the second panel has the same length in the front and rear direction as the first panel, and the second panel is coupled to the first panel.

Other detailed matters of the exemplary embodiment are included in the detailed description and the drawings.

According to the curtain airbag according to the present invention, when the curtain airbag is deployed, the folded portion protrudes further toward the interior of the vehicle than the remaining portions, and supports the head of the occupant, thereby preventing the head of the occupant from being moved forward.

The effect of the present invention is not limited to the aforementioned effect, and other effects, which are not mentioned above, will be clearly understood by those skilled in the art from the claims.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic view of a curtain airbag, a driver airbag and the head of the occupant according to the related art when viewed from the upper side.

FIG. 2 is a side view illustrating a vehicle in which a curtain airbag according to a first exemplary embodiment of the present invention is installed.

FIG. 3 is a view illustrating a curtain airbag according to the first exemplary embodiment of the present invention installed in the vehicle.

FIG. 4 is a cross-sectional view taken along line A-A of FIG. 3.

FIG. 5 is a side view illustrating the curtain airbag according to the first exemplary embodiment of the present invention.

FIG. 6 is a cross-sectional view taken along line B-B of FIG. 5.

FIG. 7 is a side view illustrating a first panel and a second panel of the curtain airbag according to the first exemplary embodiment of the present invention.

FIG. 8 is a cross-sectional view taken along line C-C of FIG. 5.

FIG. 9 is a cross-sectional view illustrating a curtain airbag according to a second exemplary embodiment of the present invention.

FIG. 10 is a cross-sectional view illustrating a curtain airbag according to a third exemplary embodiment of the present invention.

FIG. 11 is a side view illustrating a curtain airbag according to a fourth exemplary embodiment of the present invention.

FIG. 12 is a side view illustrating a curtain airbag according to a fifth exemplary embodiment of the present invention.

FIG. 13 is a side view illustrating a curtain airbag according to a sixth exemplary embodiment of the present invention.

FIG. 14 is a side view illustrating a curtain airbag according to a seventh exemplary embodiment of the present invention.

FIG. 15 is a side view illustrating a curtain airbag according to an eighth exemplary embodiment of the present invention.

FIG. 16 is a side view illustrating a curtain airbag according to a ninth exemplary embodiment of the present invention.

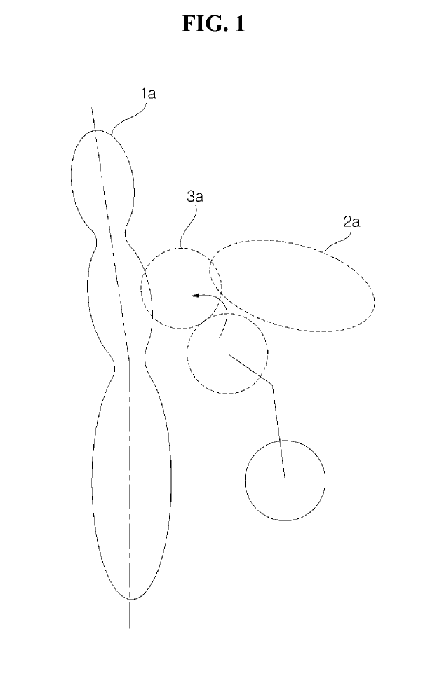

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Hereinafter, a curtain airbag according to exemplary embodiments of the present invention will be described with reference to the drawings.

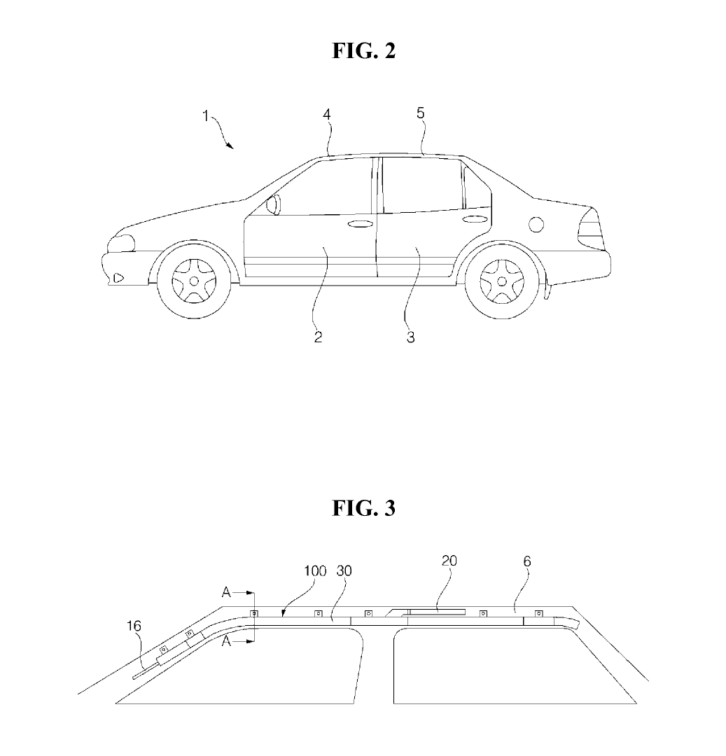

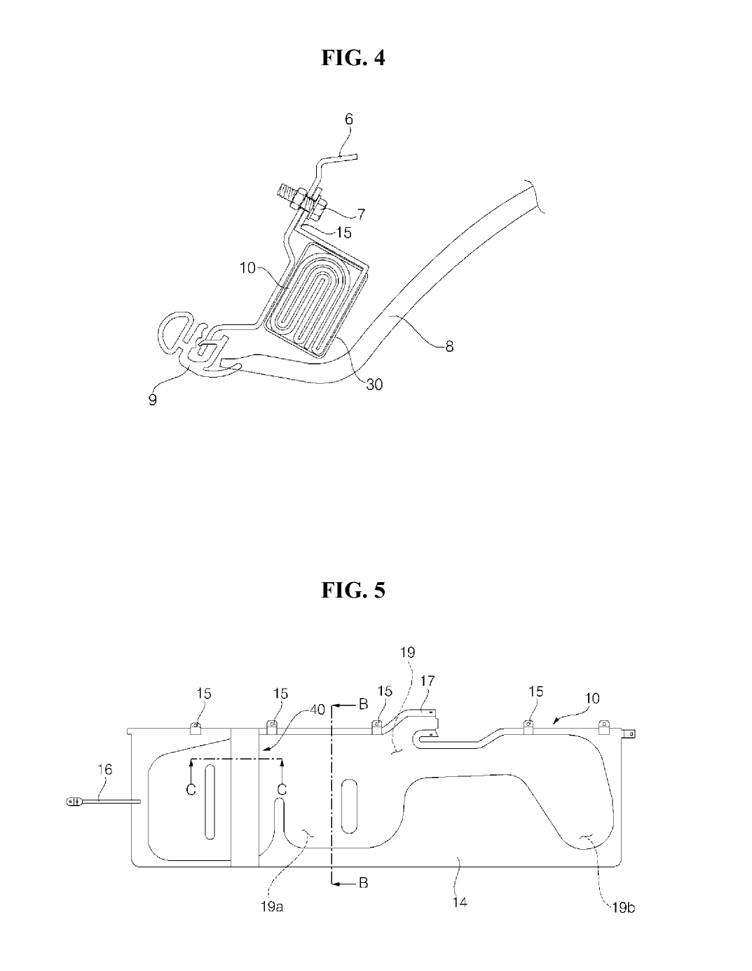

FIG. 2 is a side view illustrating a vehicle in which a curtain airbag according to a first exemplary embodiment of the present invention is installed, FIG. 3 is a view illustrating a state in which the curtain airbag according to the first exemplary embodiment of the present invention is installed in the vehicle, and FIG. 4 is a cross-sectional view taken along line A-A of FIG. 3.

Referring to FIGS. 2, 3, and 4, a curtain airbag apparatus 100, which includes a curtain airbag 10 according to a first exemplary embodiment of the present invention, is mounted at the upper side of a vehicle 1 and elongated in a front and rear direction.

Front doors 2 and rear doors 3, through which occupants (including both a driver and a passenger) get in and out of the vehicle 1, are provided at lateral sides of the vehicle 1. An A pillar 4 is disposed at the upper side of the front door 2, a C pillar 5 is disposed at the upper side of the rear door 3, and a B pillar (not illustrated) is disposed between the front door 2 and the rear door 3 and elongated in an up and down direction.

The curtain airbag apparatus 100 is mounted in an inner side panel 6, which is disposed inside the A pillar 4 and the C pillar 5, and elongated in the front and rear direction.

The curtain airbag apparatus 100 includes an inflator 20 which generates gas, and an airbag 10 which is connected with the inflator 20, and inflated and deployed when gas generated by the inflator 20 flows into the airbag 10 so as to protect the head of the passenger.

The airbag 10 is folded and then encapsulated in a cushion cover 30, and mounted in the inner side panel 6, which is disposed inside of the A pillar 4 and the C pillar 5, by a fastening member 7.

The curtain airbag apparatus 100 is covered by a headliner 8 such that the curtain airbag apparatus 100 is not visible from the interior of the vehicle. The headliner 8 refers to a member which is made of woven or non-woven fabric and covers a roof panel (not illustrated) of the vehicle 1 from the interior of the vehicle 1. The headliner 8 is retained by a weather strip 9 disposed at a lower end of the inner side panel 6, and when the airbag 10 is inflated, the headliner 8 is spread while being detached from the weather strip 9 by expansive force of the airbag 10. The airbag 10 then escapes from an open gap between the weather strip 9 and the headliner 8 and is deployed so as to be disposed between the head of the occupant and the front door 2 and the rear door 3, thereby protecting the head of the occupant.

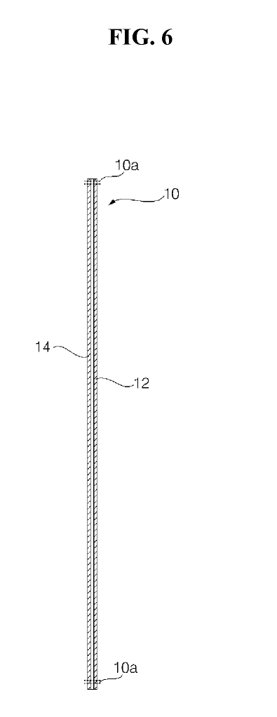

FIG. 5 is a side view illustrating the curtain airbag according to the first exemplary embodiment of the present invention, and FIG. 6 is a cross-sectional view taken along line B-B of FIG. 5.

Referring to FIGS. 5 and 6, a plurality of mounting tabs 15, which are mounted on the inner side panel 6, are formed at the upper side of the airbag 10. The mounting tabs 15 are mounted on the inner side panel 6 by the fastening members 7 illustrated in FIG. 4.

An inflator connecting portion 17, which is connected with the inflator 20, is formed at an upper central portion of the airbag 10. The airbag 10 is inflated and deployed by gas that is generated by the inflator 20 and flows into a chamber 19 of the airbag 10.

An A pillar tether 16, which is fixed to the inner side panel 6 disposed inside the A pillar 4, is coupled to the front side of the airbag 10. Therefore, the front side of the airbag 10 is restricted by the A pillar tether 16 when the airbag 10 is inflated, such that the airbag 10 may be deployed without being tilted rearward.

The airbag 10 may be formed by sewing two flexible panels together. That is, the airbag 10 includes a first panel 12 which forms one surface, and a second panel 14 which forms the other surface that is opposite to the first panel 12.

The first panel 12 and the second panel 14 face each other, and then circumferences of the first panel 12 and the second panel 14 are coupled by sewing 10a, and as a result, the airbag 10 is completely manufactured. However, the coupling method is not limited thereto and the first and second panels 12 and 14 may alternately be formed as one unit and/or folded and sewn at one end.

Before gas flows into the chamber 19 comprising an internal space between the first panel 12 and the second panel 14, the first panel 12 and the second panel 14 are disposed in a flat state while facing each other. When the airbag 10 is deployed, the first panel 12 is directed toward the outside of the vehicle 1, and the second panel 14 is directed toward the occupant.

The chamber 19 includes a front chamber 19a which is disposed at the front side based on a center in the front and rear direction of the airbag 10, and a rear chamber 19b which is disposed at the rear side based on the center in the front and rear direction of the airbag 10.

The front chamber 19a defines a region for protecting an occupant seated in a front seat, and the rear chamber 19b defines a region for protecting an occupant seated in a rear seat.

The airbag 10 has a folded portion 40. The folded portion 40 is formed on the second panel 14 which is a panel disposed to be directed toward the occupant when the airbag 10 is deployed. The folded portion 40 is unfolded and protrudes toward the interior of the vehicle when gas flows into the chamber 19, thereby preventing the head of the occupant from being moved forward and becoming trapped between the airbag 10 and the driver airbag 2a or the passenger airbag as mentioned above.

Hereinafter, the folded portion 40 will be described in detail.

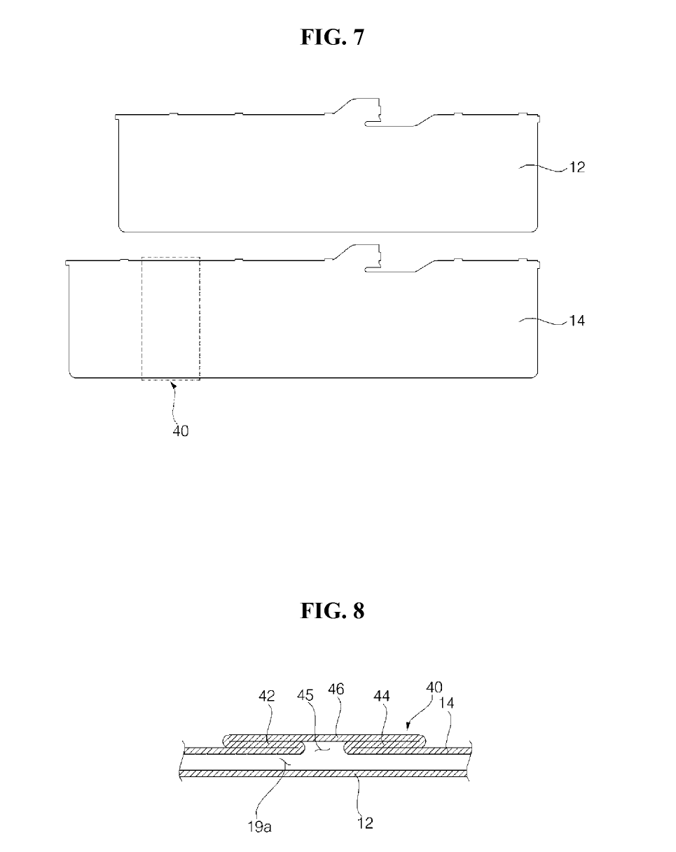

FIG. 7 is a side view illustrating the first panel 12 and the second panel 14 of the curtain airbag according to the first exemplary embodiment of the present invention, which illustrates a state before the first panel 12 and the second panel 14 are coupled to each other.

Referring to FIG. 7, the second panel 14 is formed to be longer than the first panel 12 in the front and rear direction. A portion of the second panel 14, which is defined by a dotted line, is a portion that is folded to become the folded portion 40.

The folded portion 40 may be formed by folding a portion of the dotted line having a length in the front and rear direction that is obtained by subtracting a length in the front and rear direction of the first panel 12 from a length in the front and rear direction of the second panel 14. Therefore, the first panel 12 and the second panel 14 have the same length in the front and rear direction when the folded portion 40 is formed. In this state, when the second panel 14 is placed on the first panel 12, the first panel 12 and the second panel 14 overlap each other. Thereafter, the circumferences of the first panel 12 and the second panel 14 are coupled, such as by sewing 10a, so that the first panel 12 and the second panel 14 are coupled. As a result, the airbag 10 may be completely manufactured, as illustrated in FIG. 5.

The folded portion 40 is formed by being folded from an upper end to a lower end of the second panel 14. When the circumferences of the first panel 12 and the second panel 14 are coupled by sewing 10a, each of the upper end and the lower end of the folded portion 40 is also coupled to the first panel 12 by sewing 10a.

Since only the upper end and the lower end of the folded portion 40 are coupled to the first panel 12, the folded portion 40 may be unfolded by the pressure of gas flowing into the chamber 19 comprising the internal space between the first panel 12 and the second panel 14, and then protrude from the second panel 14.

The upper end and the lower end of the folded portion 40 are disposed at the same position in the front and rear direction. That is, in a state in which the folded portion 40 is formed, folded lines of the folded portion 40 are vertically disposed.

The folded portion 40 may be formed at a portion of the second panel 14 where the front chamber 19a is formed. That is, the folded portion 40 may be formed at a position corresponding to a position at which a driver airbag is inflated or a position at which a passenger airbag is inflated.

In the case in which the driver airbag is installed at the left side in the interior of the vehicle and the passenger airbag is installed at the right side in the interior of the vehicle, the folded portion 40 of the curtain airbag 10, which is installed at the left side of the vehicle 1, may be formed at a position corresponding to a position at which the driver airbag is inflated, and as a result, the folded portion 40 protrudes toward the inflated driver airbag when the airbag 10 is deployed. Therefore, the folded portion 40 blocks a gap between the curtain airbag 10 and the inflated driver airbag, thereby preventing the head of the occupant seated in the driver seat from being trapped in the gap between the driver airbag and the curtain airbag 10 while the head of the occupant is moved forward, such as when the vehicle 1 obliquely collides with an object. Similarly, in the case where the folded portion 40 of the curtain airbag 10 is installed at the right side of the vehicle 1, folded portion 40 may be formed at a position corresponding to a position at which the passenger airbag is inflated. The folded portion 40 protrudes toward the inflated passenger airbag when the airbag 10 is deployed. Therefore, the folded portion 40 blocks a gap between the curtain airbag 10 and the inflated passenger airbag, thereby preventing the head of the occupant seated in the front passenger seat from being trapped in the gap between the passenger airbag and the curtain airbag 10 while the head of the occupant is moved forward, such as when the vehicle 1 obliquely collides with an object.

Of course, a folded portion 40 may also be formed at a portion of the second panel 14 where the rear chamber 19b is formed, and may be formed at both the portion of the second panel 14 where the front chamber 19a is formed and the portion of the second panel 14 where the rear chamber 19b is formed. That is, the folded portion 40 may be formed at at least one of the front portion and the rear portion based on the center in the front and rear direction of the curtain airbag 10.

FIG. 8 is a cross-sectional view taken along line C-C of FIG. 5.

Referring to FIG. 8, the folded portion 40 includes a first folded portion 42 and a second folded portion 44 which are in direct contact with the second panel 14, an opening 45 formed between the second folded portion 44 and the first folded portion 42 that connects to an internal space between the first panel 12 and the second panel 14, and a third folded portion 46 which is in direct contact with the first folded portion 42 and the second folded portion 44.

The first folded portion 42 is folded forward and is in direct contact with an upper portion of the second panel 14. The second folded portion 44 is folded rearward, in a direction opposite to the direction in which the first folded portion 42 is folded, and is also in direct contact with the upper portion of the second panel 14.

One end of the first folded portion 42 extends from the second panel 14, and one end of the second folded portion 44 also extends from the second panel 14. Further, one end of the third folded portion 46 extends from the other end of the first folded portion 42, and the other end of the third folded portion 46 extends from the other end of the second folded portion 44.

Meanwhile, the folded shape of the folded portion 40 may vary.

FIG. 9 is a cross-sectional view illustrating a curtain airbag according to a second exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 9, it can be seen that the curtain airbag according to the second exemplary embodiment of the present invention differs from the curtain airbag illustrated in FIG. 8. That is, the folded portion 40 includes a first folded portion 42 which is in direct contact with the second panel 14, and a second folded portion 44 which is in direct contact with the first folded portion 42, and an opening 45 formed between the second folded portion 44 and the first folded portion 42 which is connected to the internal space between the first panel 12 and the second panel 14.

The first folded portion 42 is folded rearward and then is in direct contact with an upper portion of the second panel 14, and the second folded portion 44 is also folded rearward and then is in direct contact with an upper portion of the first folded portion 42.

One end of the first folded portion 42 extends from the second panel 14, and one end of the second folded portion 44 also extends from the second panel 14. Further, the other end of the second folded portion 44 extends from the other end of the first folded portion 42.

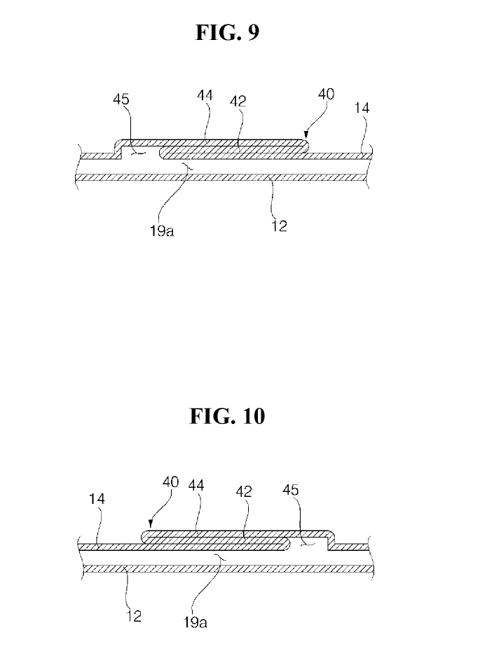

FIG. 10 is a cross-sectional view illustrating a curtain airbag according to a third exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 10, it can be seen that the curtain airbag according to the third exemplary embodiment of the present invention differs from the curtain airbag illustrated in FIG. 9. According to the curtain airbag according to the third exemplary embodiment of the present invention, the folded portion 40 is folded in a direction reverse to a direction illustrated in FIG. 9.

That is, the folded portion 40 includes a first folded portion 42 which is in direct contact with the second panel 14, and a second folded portion 44 which is in direct contact with the first folded portion 42, and an opening 45 formed between the second folded portion 44 and the first folded portion 42 which is connected to the internal space between the first panel 12 and the second panel 14.

The first folded portion 42 is folded forward and then is in direct contact with an upper portion of the second panel 14, and the second folded portion 44 is also folded forward and then is in direct contact with an upper portion of the first folded portion 42.

One end of the first folded portion 42 extends from the second panel 14, and one end of the second folded portion 44 also extends from the second panel 14. Further, the other end of the second folded portion 44 extends from the other end of the first folded portion 42.

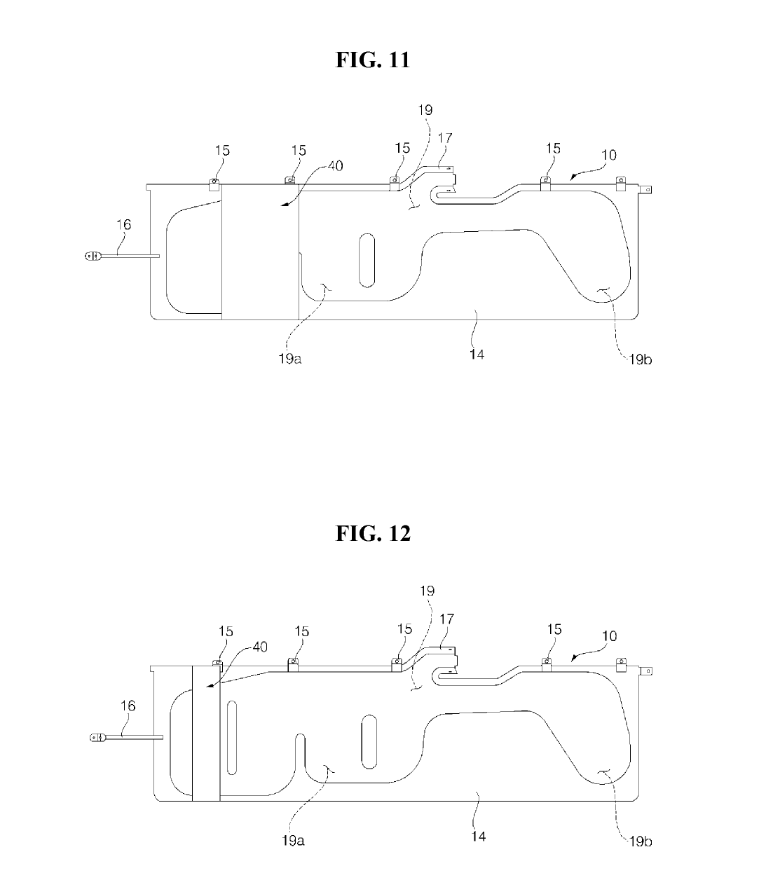

Meanwhile, a degree at which the folded portion 40 protrudes toward the interior of the vehicle while being spread may vary. The degree at which the folded portion protrudes will be described with reference to FIG. 11.

FIG. 11 is a side view illustrating a curtain airbag according to a fourth exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 11, it can be seen that the curtain airbag according to the fourth exemplary embodiment of the present invention differs from the curtain airbag illustrated in FIG. 5. That is, the folded portion 40 is greater in width (i.e., in the left and right direction) than the folded portion 40 illustrated in FIG. 5. Therefore, in a state in which the airbag 10 is deployed, the folded portion 40 may protrude further toward the interior of the vehicle than the folded portion 40 in the aforementioned first exemplary embodiment.

The folded portion 40, which is greater in length in the front and rear direction of the second panel 14 than the folded portion 40 in the aforementioned first exemplary embodiment, is prepared, and then formed by being folded so that the length in the front and rear direction of the second panel 14 is equal to the length in the front and rear direction of the first panel 12, such that the folded portion 40 may be greater in width in the left and right direction than the folded portion 40 in the aforementioned first exemplary embodiment.

Meanwhile, the position of the folded portion 40 may vary. The position of the folded portion 40 will be described with reference to FIGS. 12 to 14.

FIG. 12 is a side view illustrating a curtain airbag according to a fifth exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 12, it can be seen that the curtain airbag according to the fifth exemplary embodiment of the present invention differs from the curtain airbag illustrated in FIG. 5. That is, the position of the folded portion 40 is further forward than the position of the folded portion 40 in the aforementioned first exemplary embodiment. Therefore, when the vehicle 1 obliquely collides with an object, the head of the occupant comes into contact with the folded portion 40 more slowly in comparison with the aforementioned first exemplary embodiment, and as a result, an amount of impact, which is applied to the folded portion 40 by the head of the occupant, is less than that in the aforementioned first exemplary embodiment, such that the folded portion 40 may rigidly support the head of the occupant in comparison with the aforementioned first exemplary embodiment.

The folded portion 40 protrudes further forward from a position at which the driver airbag is inflated or a position at which the passenger airbag is inflated, thereby blocking a gap between the curtain airbag and the driver airbag, or blocking a gap between the curtain airbag and the passenger airbag.

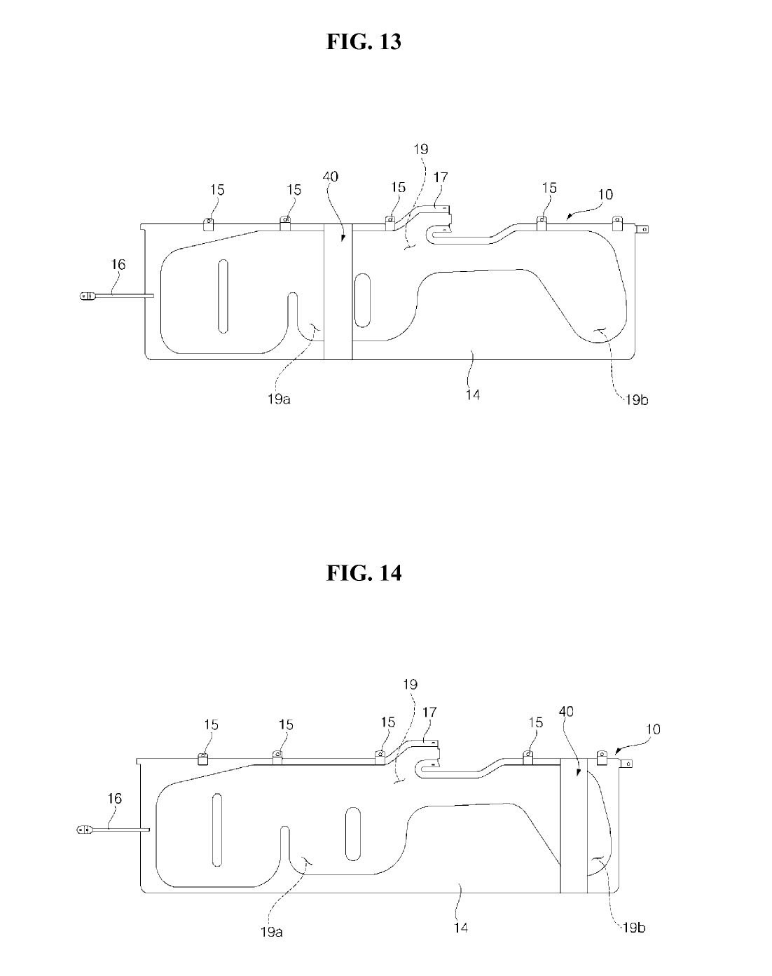

FIG. 13 is a side view illustrating a curtain airbag according to a sixth exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 13, it can be seen that the curtain airbag according to the sixth exemplary embodiment of the present invention differs from the curtain airbag illustrated in FIG. 5. That is, the folded portion 40 is disposed further rearward than the folded portion 40 in the aforementioned first exemplary embodiment. The folded portion 40 is positioned slightly forward from the occupant seated in the front seat, thereby more quickly restricting the head of the occupant, which is moved forward, in comparison with the aforementioned first exemplary embodiment.

FIG. 14 is a side view illustrating a curtain airbag according to a seventh exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 14, it can be seen that the curtain airbag according to the seventh exemplary embodiment of the present invention differs from the curtain airbag illustrated in FIG. 5. That is, in the aforementioned first exemplary embodiment, the folded portion 40 is formed in the front chamber 19a, but in the present seventh exemplary embodiment, the folded portion 40 is formed in the rear chamber 19b. In other words, in the aforementioned first exemplary embodiment, the folded portion 40 is formed at a position that corresponds to the occupant seated in the front seat, but in the present seventh exemplary embodiment, the folded portion 40 is formed at a position that corresponds to the occupant seated in the rear seat.

Therefore, when the vehicle 1 obliquely collides with an object, the folded portion 40 prevents the head of the occupant seated in the rear seat from being moved forward, thereby preventing the head of the occupant seated in the rear seat from being trapped in a gap between a backrest of the front seat and the curtain airbag 10.

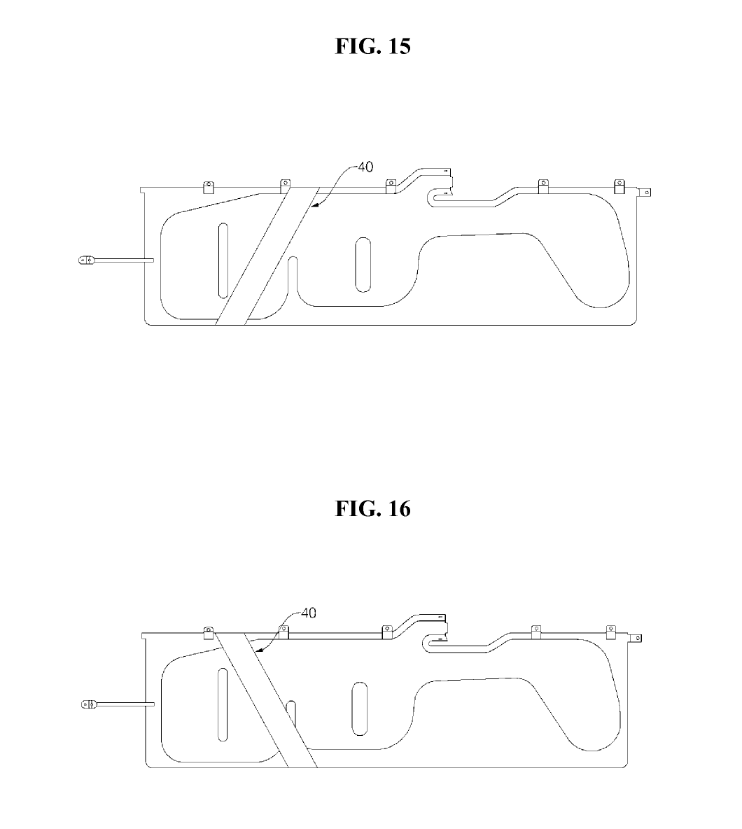

Meanwhile, an angle at which the folded portion 40 protrudes toward the interior of the vehicle may vary. The angle at which the folded portion protrudes will be described with reference to FIGS. 15 and 16.

FIG. 15 is a side view illustrating a curtain airbag according to an eighth exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 15, it can be seen that the curtain airbag according to the eighth exemplary embodiment of the present invention differs from the curtain airbag illustrated in FIG. 5. That is, in the aforementioned first exemplary embodiment, the upper end and the lower end of the folded portion 40 are disposed at the same position in the front and rear direction, such that the folded lines of the folded portion 40 are vertically disposed in the up and down direction, but in the present eighth exemplary embodiment, the upper end of the folded portion 40 is disposed further rearward than the lower end of the folded portion 40, such that the folded lines of the folded portion 40 are inclined.

FIG. 16 is a side view illustrating a curtain airbag according to a ninth exemplary embodiment of the present invention. Hereinafter, like reference numerals refer to constituent elements identical to those of the aforementioned first exemplary embodiment, a description thereof will be omitted, and only differences between the exemplary embodiments will be described.

Referring to FIG. 16, it can be seen that the curtain airbag according to the ninth exemplary embodiment of the present invention differs from the curtain airbag illustrated in FIG. 5. That is, in the aforementioned first exemplary embodiment, the upper end and the lower end of the folded portion 40 are disposed at the same position in the front and rear direction, such that the folded lines of the folded portion 40 are vertically disposed in the up and down direction, but in the present ninth exemplary embodiment, the upper end of the folded portion 40 is disposed further forward than the lower end of the folded portion 40, such that the folded lines of the folded portion 40 are inclined.

According to the curtain airbag 10 according to the present invention as described above, when the curtain airbag 10 is deployed, the folded portion 40 further protrudes toward the interior of the vehicle than the remaining portions, and supports the head of the occupant, thereby preventing the head of the occupant from being moved forward.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A curtain airbag comprising:
a first panel which forms one surface; and
a second panel which forms the other surface, and is greater in length in a front and rear direction than the first panel,
wherein the second panel has a folded portion which is folded so that the second panel has the same length in the front and rear direction as the first panel, and the second panel is coupled to the first panel.

2. The curtain airbag of claim 1, wherein the folded portion is formed by being folded from an upper end to a lower end of the second panel, and each of the upper end and the lower end is coupled to the first panel.

3. The curtain airbag of claim 1, wherein the folded portion is configured to spread by pressure of a gas flowing into an internal space between the first panel and the second panel, and protrude further than the second panel.

4. The curtain airbag of claim 1, wherein an upper end and a lower end of the folded portion are disposed at a same position in a front and rear direction.

5. The curtain airbag of claim 1, wherein an upper end of the folded portion is disposed at a different position from a lower end of the folded portion in a front and rear direction.

6. The curtain airbag of claim 1, wherein the folded portion comprises:
a first folded portion and a second folded portion which are in direct contact with the second panel; and
a third folded portion which is in direct contact with the first folded portion and the second folded portion;
wherein an opening connected to an internal space between the first panel and the second panel is formed between the first folded portion and the second folded portion.

7. The curtain airbag of claim 1, wherein the folded portion includes:
a first folded portion which is in direct contact with the second panel; and
a second folded portion which is in direct contact with the first folded portion;
wherein an opening connected to an internal space between the first panel and the second panel is formed between the first folded portion and the second folded portion.

8. The curtain airbag of claim 1, wherein the folded portion is formed at at least one of a front side and a rear side based on a center in the front and rear direction of the curtain airbag.

9. The curtain airbag of claim 1, wherein the folded portion is formed at a position that corresponds to a position at which one of a driver airbag and a passenger airbag is inflated.

10. The curtain airbag of claim 1, wherein the folded portion is formed at a position that corresponds to a position at which an occupant is seated in a front seat.

11. The curtain airbag of claim 1, wherein the folded portion is formed at a position that corresponds to a position at which an occupant is seated in a rear seat.

12. A curtain airbag comprising:
a first panel;
a second panel coupled to the first panel; and
a chamber formed between the first panel and the second panel;
wherein the second panel has at least one or more folded portions; and
the folded portion is configured to unfold toward an interior of a vehicle when gas flows into the chamber.

13. The curtain airbag of claim 12, wherein each of an upper end and a lower end of the folded portion is coupled to the first panel.

14. The curtain airbag of claim 12, wherein the folded portion comprises:
a first folded portion and a second folded portion which are in direct contact with the second panel; and
a third folded portion which is in direct contact with the first folded portion and the second folded portion;
wherein an opening connected to the chamber is formed between the first folded portion and the second folded portion.

15. The curtain airbag of claim 12, wherein the folded portion includes:
a first folded portion which is in direct contact with the second panel; and
a second folded portion which is in direct contact with the first folded portion;
wherein an opening connected to the chamber is formed between the first folded portion and the second folded portion.
